(19) United States
(12) Patent Application Publication
(10) Pub. No.: US 2026/0003119 A1
(43) Pub. Date: Jan. 1, 2026

(54) PHOTONIC INTEGRATED CIRCUIT, METHOD OF MANUFACTURING THE PHOTONIC INTEGRATED CIRCUIT, AND ELECTRONIC APPARATUS INCLUDING THE PHOTONIC INTEGRATED CIRCUIT

(71) Applicant: SAMSUNG ELECTRONICS CO., LTD., Suwon-si (KR)

(72) Inventors: Jungho CHA, Suwon-si (KR); Woosung KIM, Suwon-si (KR); Hyunil BYUN, Suwon-si (KR); Changgyun SHIN, Suwon-si (KR); Dongsik SHIM, Suwon-si (KR); Bongyong JANG, Suwon-si (KR)

(73) Assignee: SAMSUNG ELECTRONICS CO., LTD., Suwon-si (KR)

(21) Appl. No.: 19/022,294

(22) Filed: Jan. 15, 2025

(30) Foreign Application Priority Data
Jul. 1, 2024 (KR) 10-2024-0086351

(51) Int. Cl. G02B 6/12; G02B 6/136

(52) U.S. Cl. CPC G02B 6/12004; G02B 6/136; G02B 2006/121; G02B 2006/12109; G02B 2006/12121; G02B 2006/12123; G02B 2006/12142; G02B 2006/12147

(57) ABSTRACT

Provided is a photonic integrated circuit including a substrate including a trench, a light source on the substrate and adjacent to the trench, the light source including a first electrode and a second electrode that are in an upper portion of the light source, at least one optical element on the substrate and optically connected to the light source, and a waveguide between the light source and the at least one optical element, wherein the substrate includes a first semiconductor layer, a dielectric layer on the first semiconductor layer, and a second semiconductor layer on the dielectric layer, the trench penetrates the second semiconductor layer and the dielectric layer, and the first electrode includes an extension on a side wall surface of the light source and in the trench, the light source further includes a first reflective surface and a second reflective surface that are spaced apart from each other.

### CROSS-REFERENCE TO RELATED APPLICATION

This application claims priority to Korean Patent Application No. 10-2024-0086351, filed on Jul. 1, 2024, in the Korean Intellectual Property Office, the disclosure of which is incorporated by reference herein in its entirety.

### BACKGROUND

### 1. Field

Embodiments of the present disclosure relate to optical interconnections, and more particularly, to a photonic integrated circuit, a method of manufacturing the photonic integrated circuit, and an electronic apparatus including the photonic integrated circuit.

### 2. Description of Related Art

Data transmission using photons has been increasingly needed for overcoming limitations associated with the use of copper wire connections in high-speed, large-capacity data communication between racks in data centers.

When photons are used for data transmission between a processor and memory, there is a need to miniaturize components used in long-distance optical communication.

To address this need, there is growing interest in techniques for simultaneously integrating a light source and a photonic integrated circuit (PIC) by hybrid integration of a III/V light source on a silicon-on-insulator (SOI) substrate.

### SUMMARY

One or more embodiments provide a photonic integrated circuit, a method of manufacturing the photonic integrated circuit, and an electronic apparatus including the photonic integrated circuit.

Technical aspects of the disclosure are not limited thereto, and the disclosure may have other aspects.

Additional aspects will be set forth in part in the description which follows and, in part, will be apparent from the description, or may be learned by practice of one or more embodiments of the disclosure.

According to an aspect of one or more embodiments, there is provided a photonic integrated circuit including a substrate including a trench, a light source on the substrate and adjacent to the trench, the light source including a first electrode and a second electrode that are in an upper portion of the light source, at least one optical element on the substrate and optically connected to the light source, and a waveguide between the light source and the at least one optical element, wherein the substrate includes a first semiconductor layer, a dielectric layer on the first semiconductor layer, and a second semiconductor layer on the dielectric layer, wherein the trench penetrates the second semiconductor layer and the dielectric layer to a level of the first semiconductor layer, and wherein the first electrode includes an extension on a side wall surface of the light source and in the trench, the light source further includes a first reflective surface and a second reflective surface that are spaced apart from each other, the first reflective surface being the extension of the first electrode.

The light source may include a Group III-V compound semiconductor material, and the at least one optical element may include a plurality of ring resonators and a plurality of optical amplifiers.

The light source may be a Fabry-Perot hybrid laser diode, and the at least one optical element may include a plurality of ring resonators and a plurality of optical amplifiers.

The extension of the first electrode may include a first surface, a second surface, and a third surface, the first surface may extend from an end of the upper portion of the light source to the first semiconductor layer along the side wall surface of the light source, the second surface may extend from an end of the first surface in a direction parallel to the first semiconductor layer, the third surface may extend from an end of the second surface to the second semiconductor layer, and the first reflective surface may be the first surface.

An end of the waveguide through which light emitted from the light source enters the waveguide may be at an angle with respect to a plane perpendicular to a direction in which the light enters the waveguide.

The angle between an end of the waveguide, through which light emitted from the light source enters the waveguide, and a plane perpendicular to a direction in which the light enters the waveguide may be within a range of 3 degrees to 17 degrees.

The at least one optical element may include at least one optical amplifier and at least one photodetector, and the light source, the at least one optical amplifier, and the at least one photodetector each may include a Group III-V compound semiconductor material and are in a region of the substrate.

The at least one optical element may include at least one optical amplifier and at least one photodetector, and the light source, the at least one optical amplifier, and the at least one photodetector each may include a Group III-V compound semiconductor material and are in a region of the substrate that is a rectangular region at a center of a surface of the substrate.

The at least one optical element may include an optical coupler, at least one ring resonator, at least one optical amplifier, and at least one photodetector, and the light source, the at least one optical amplifier, and the at least one photodetector each may include a Group III-V compound semiconductor material and are in a first region of the substrate, and the optical coupler and the at least one ring resonator may be in a second region of the substrate different from the first region of the substrate.

The at least one optical element may include an optical coupler, at least one ring filter, at least one ring modulator, at least one optical amplifier, and at least one photodetector, and the light source, the at least one optical amplifier, and the at least one photodetector each may include a Group III-V compound semiconductor material and are in a first region of the substrate, the at least one ring filter may be in a second region of the substrate different from the first region, and the optical coupler and the at least one ring modulator may be in a third region of the substrate different from the first region and the second region.

According to another aspect of one or more embodiments, there is provided a method of manufacturing a photonic integrated circuit, the method including forming a substrate by providing a first semiconductor layer, a dielectric layer, and a second semiconductor layer, providing a light source, a waveguide, and at least one optical element on the substrate, forming a trench by etching a portion of the substrate, the portion being adjacent to the light source, and providing a first electrode and a second electrode on the light source, wherein the trench is formed to penetrate the second semiconductor layer and the dielectric layer to a level of the first semiconductor layer, and wherein the first electrode includes an extension on a side wall surface of the light source and in the trench, the light source includes a first reflective surface and a second reflective surface, the first reflective surface being the extension of the first electrode.

The light source may include a Group III-V compound semiconductor material, and the at least one optical element may include a plurality of ring resonators and a plurality of optical amplifiers.

The light source may be a Fabry-Perot hybrid laser diode, and the at least one optical element may include a plurality of ring resonators and a plurality of optical amplifiers.

The extension of the first electrode may include a first surface, a second surface, and a third surface, the first surface may extend from an end of the upper portion of the light source to the first semiconductor layer along the side wall surface of the light source, the second surface may extend from an end of the first surface in a direction parallel to the first semiconductor layer, the third surface may extend from an end of the second surface to the second semiconductor layer, and the first reflective surface may be the first surface.

An end of the waveguide through which light emitted from the light source enters the waveguide may be at an angle with respect to a plane perpendicular to a direction in which the light enters the waveguide.

The angle between an end of the waveguide, through which light emitted from the light source enters the waveguide, and a plane perpendicular to a direction in which the light enters the waveguide may be within a range of 3 degrees to 17 degrees.

The at least one optical element may include at least one optical amplifier and at least one photodetector, and the light source, the at least one optical amplifier, and the at least one photodetector each may include a Group III-V compound semiconductor material and are in a region of the substrate.

The at least one optical element may include at least one optical amplifier and at least one photodetector, and the light source, the at least one optical amplifier, and the at least one photodetector each may include a Group III-V compound semiconductor material and are in a region of the substrate that is a rectangular region at a center of a surface of the substrate.

The at least one optical element may include an optical coupler, at least one ring resonator, at least one optical amplifier, and at least one photodetector, and the light source, the at least one optical amplifier, and the at least one photodetector each may include a Group III-V compound semiconductor material and are in a first region of the substrate, and the optical coupler and the at least one ring resonator may be in a second region of the substrate different from the first region of the substrate.

The at least one optical element may include an optical coupler, at least one ring filter, at least one ring modulator, at least one optical amplifier, and at least one photodetector, and the light source, the at least one optical amplifier, and the at least one photodetector each may include a Group III-V compound semiconductor material and are in a first region of the substrate, the at least one ring filter may be in a second region of the substrate different from the first region, and the optical coupler and the at least one ring modulator may be in a third region of the substrate different from the first region and the second region.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram illustrating a photonic integrated circuit according to one or more embodiments, and FIG. 2 is a schematic enlarged diagram illustrating some components of the photonic integrated circuit provided in a region A of FIG. 1;

FIG. 3 is a schematic cross-sectional diagram taken along ling B-B′ of FIG. 2;

FIG. 4 is a schematic enlarged diagram illustrating a region C of FIG. 2;

FIG. 5 is a schematic diagram illustrating a photonic integrated circuit according to another embodiment;

FIGS. 6 to 11 are schematic diagrams illustrating a method of manufacturing a photonic integrated circuit according to one or more embodiments; and

FIG. 12 is a schematic block diagram illustrating an electronic apparatus including a photonic integrated circuit according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

A photonic integrated circuit, a method of manufacturing the photonic integrated circuit, and an electronic apparatus including the photonic integrated circuit will now be described according to embodiments with reference to the accompanying drawings. In the drawings, the thicknesses of layers or regions may be exaggerated for clarity of illustration.

Embodiments described herein are for illustrative purposes only, and various modifications may be made therein. In the following descriptions of layer structures, when a layer is referred to as being “above” or “on” another layer, it may be directly on the other layer while making contact with the other layer or may be above the other layer without making contact with the other layer. In the drawings, like reference numerals refer to like elements.

The terms of a singular form may include plural forms unless otherwise mentioned. It will be further understood that the terms “comprises” and/or “comprising” used herein specify the presence of stated features or elements, but do not preclude the presence or addition of one or more other features or elements.

An element referred to with the definite article or a demonstrative determiner may be construed as the element or the elements even though it has a singular form. Operations of a method may be performed in an appropriate order unless explicitly described in terms of order or described to the contrary. That is, operations of a method are not limited to the stated order thereof.

In the disclosure, terms such as “unit” or “module” may be used to denote a unit that has at least one function or operation and is implemented with hardware, software, or a combination of hardware and software.

Furthermore, line connections or connection members between elements depicted in the drawings represent functional connections and/or physical or circuit connections by way of example, and in actual applications, they may be replaced or embodied with various additional functional connections, physical connections, or circuit connections.

Examples or exemplary terms are just used herein to describe technical ideas and should not be considered for purposes of limitation unless defined by the claims.

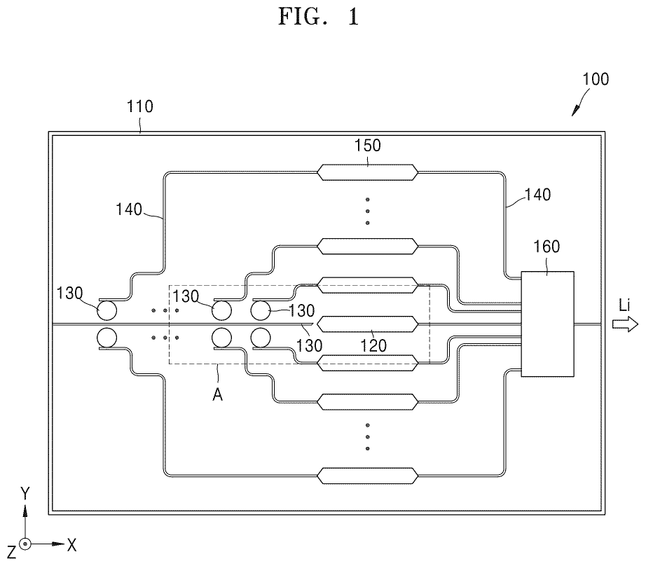

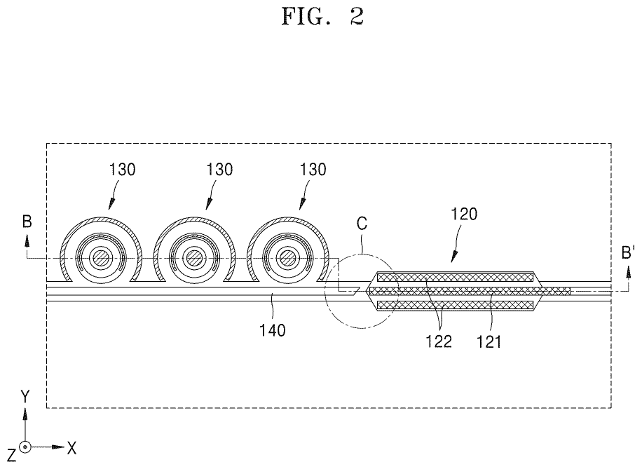

FIG. 1 is a schematic diagram illustrating a photonic integrated circuit (PIC) 100 according to one or more embodiments, and FIG. 2 is an enlarged diagram illustrating some components of the PIC 100 provided in a region A of FIG. 1.

Referring to FIGS. 1 and 2, the PIC 100 may include a substrate 110, a light source 120, at least one optical element, and a waveguide 140. The light source 120, the at least one optical element, and the waveguide 140 may be provided on the substrate 110. The at least one optical element may include at least one of a ring resonator 130, an optical amplifier 150, and an optical coupler 160. FIG. 2 illustrates only some of components shown in FIG. 1, and the rest of the components are omitted for ease of illustration.

The substrate 110 may include a plurality of semiconductor layers and dielectric layers (insulating layers) provided between the plurality of semiconductor layers. For example, the substrate 110 may be a silicon-on-insulator (SOI) substrate.

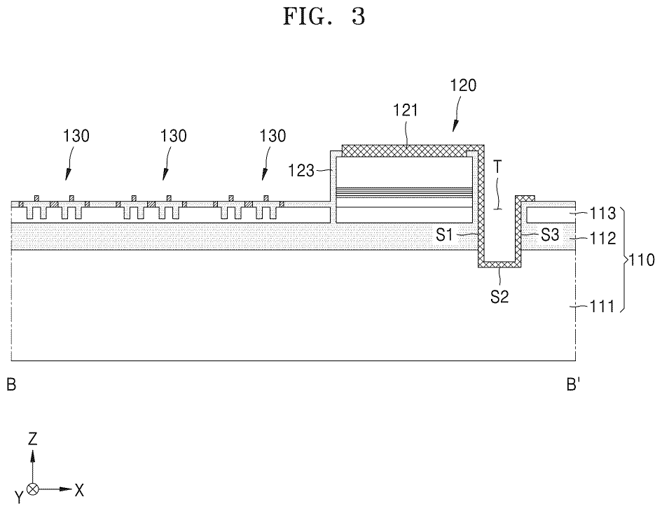

The light source 120 may be provided on the substrate 110. For example, the light source 120 may be provided in a third direction (Z direction) that is the thickness direction of the substrate 110. The light source 120 may include a Group III-V compound semiconductor material. For example, the light source 120 may include gallium nitride (GaN). For example, the light source 120 may be a hybrid laser diode that is provided on a silicon-containing second semiconductor layer (refer to reference numeral 113 in FIG. 3) of the substrate 110 and uses a heterojunction between silicon and a Group III-V compound semiconductor. The light source 120 may include a plurality of reflective surfaces (for example, a first reflective surface and a second reflective surface) and a cavity provided between the first and second reflective surfaces. For example, the light source 120 may be a Fabry-Perot hybrid laser diode. The cavity may have a length of less than or equal to about 200 μm. The light source 120 may include a multiple quantum well (MQW) structure or a quantum dot structure. The light source 120 may include a first electrode 121 and a second electrode 122 that are provided in an upper portion of the light source 120. The first electrode 121 may be a p-type electrode, and the second electrode 122 may be an n-type electrode. Each of the first electrode 121 and the second electrode 122 may include an element selected from gold (Au), aluminum (AI), silver (Ag), and a combination thereof. The first electrode 121 and the second electrode 122 may include the same material. However, embodiments are not limited thereto, and for example, the first electrode 121 and the second electrode 122 may include different materials. The first electrode 121 may include a metallic material with low infrared absorption or an alloy thereof. For example, the first electrode 121 may include chromium (Cr), gold (Au), or a combination thereof. However, embodiments are not limited thereto, and for example, the first electrode 121 may include titanium (Ti), gold (Au), or a combination thereof.

At least one ring resonator 130 may be provided on the substrate 110. For example, the at least one ring resonator 130 may be provided adjacent to the light source 120 on the substrate 110 in a direction opposite to a first direction (X direction). FIG. 1 illustrates an arrangement of a plurality of ring resonators 130 as an example, and various other arrangements of a plurality of ring resonators 130 are possible. The at least one ring resonator 130 may include a ring filter or a ring modulator. The at least one ring resonator 130 may be a closed-loop resonator including a ring-shaped waveguide. The at least one ring resonator 130 may filter a specific wavelength of light or modulate light.

The waveguide 140 may be provided on the substrate 110. The waveguide 140 may optically connect the light source 120 and the at least one optical element to each other. For example, the waveguide 140 may be provided between the light source 120 and the at least one ring resonator 130, between the at least one ring resonator 130 and the optical amplifier 150, between the optical amplifier 150 and the optical coupler 160, and between other components for optical connection therebetween. The waveguide 140 may be provided between the light source 120 and the at least one ring resonator 130, at a predetermined distance from the light source 120.

A plurality of optical amplifiers 150 may be provided on the substrate 110. For example, the optical amplifiers 150 may be provided adjacent to the light source 120 on the substrate 110 in a second direction (Y direction) and the opposite direction of the second direction (Y direction). Light input into the optical amplifiers 150 along the waveguide 140 may be amplified by the optical amplifiers 150. The optical amplifiers 150 may include a Group III-V compound semiconductor material. For example, the optical amplifiers 150 may include a semiconductor optical amplifier (SOA).

The optical coupler 160 may be provided on the substrate 110. For example, the optical coupler 160 may be provided adjacent to the light source 120 on the substrate 110 in the first direction (X direction). Light amplified by the optical amplifiers 150 along the waveguide 140 may be combined as a single light beam by the optical coupler 160 and may then be output from the PIC 100.

According to one or more embodiments, the PIC 100 includes a single light source, that is, the light source 120 such that the PIC 100 may maintain a constant wavelength interval regardless of changes in external factors, and includes a plurality of ring resonators 130 such that the PIC 100 may reduce optical power imbalance between wavelengths by adjusting optical power for each wavelength according to longitudinal modes. For example, the optical power of light split at the ring resonators 130 according to the wavelength of the light may be individually amplified by the optical amplifiers 150 that are respectively connected to the ring resonators 130, and thus, optical power imbalance between wavelengths may be reduced.

In the example shown in FIG. 1, the light source 120, the ring resonators 130, the waveguide 140, the optical amplifiers 150, and the optical coupler 160 are illustrated from among the components of the PIC 100 for ease of illustration. However, other elements or components such as an optical splitter or a logic transistor of the PIC 100 may be further provided on the substrate 110.

FIG. 3 is a schematic cross-sectional diagram taken along line B-B′ of FIG. 2.

Referring to FIG. 3, the substrate 110 may include a first semiconductor layer 111, a dielectric layer 112, and a second semiconductor layer 113. The first semiconductor layer 111, the dielectric layer 112, and the second semiconductor layer 113 may be sequentially stacked. The first semiconductor layer 111 and the second semiconductor layer 113 may include the same semiconductor material or different semiconductor materials. For example, the first semiconductor layer 111, the dielectric layer 112, and the second semiconductor layer 113 may form an SOI substrate. The first semiconductor layer 111 may include silicon (Si). For example, the first semiconductor layer 111 may be a silicon layer or may include a silicon layer, but embodiments are not limited thereto. For example, the dielectric layer 112 may include an oxide or nitride, but embodiments are not limited thereto. For example, the dielectric layer 112 may include silicon oxide (for example, silicon oxide (SiO₂)), but embodiments are not limited thereto. The thickness of the dielectric layer 112 may be greater than or equal to about 1 μm. The second semiconductor layer 113 may include silicon (Si). For example, the second semiconductor layer 113 may be a silicon layer or may include a silicon layer, but embodiments are not limited thereto. The thickness of the second semiconductor layer 113 may range from about 100 nm to about 400 nm. The waveguide 140 may be provided on the second semiconductor layer 113.

The substrate 110 may include a trench T provided adjacent to the light source 120. The trench T may be provided in the substrate 110 and adjacent to the light source 120 in the first direction (X direction). The trench T may be provided by etching a portion of the substrate 110 adjacent to the light source 120 to a certain height from an upper surface of the substrate 110 in the opposite direction of the third direction (Z direction). The trench T may have a height in the third direction (Z direction), a width in the first direction (X direction), and a length in the second direction (Y direction). The trench T may penetrate the second semiconductor layer 113, the dielectric layer 112, and a portion of the first semiconductor layer 111. The trench T may be provided from an upper surface of the second semiconductor layer 113 to below an upper surface of the first semiconductor layer 111. A portion of the first semiconductor layer 111 may be exposed through a lower surface of the trench T in the third direction (Z direction). The trench T may be formed to provide a reflective surface to the light source 120.

The first electrode 121 provided in the upper portion of the light source 120 may include an extension. The extension of the first electrode 121 may include a first surface S1 extending from an end of the upper portion of the light source 120 in the opposite direction of the third direction (Z direction), a second surface S2 extending from an end of the first surface S1 in the first direction (X direction), and a third surface S3 extending from an end of the second surface S2 in the third direction (Z direction). The first surface S1, the second surface S2, and the third surface S3 may be provided along the trench T formed in the substrate 110. The first surface S1 and the third surface S3 may be provided on wall surfaces of the trench T, and the second surface S2 may be provided on the lower surface of the trench T. The first surface S1 may be provided along a side wall surface of the light source 120. The first surface S1 may be provided from the upper portion of the light source 120 to below the upper surface of the first semiconductor layer 111 in a direction perpendicular to a surface of the substrate 110. The second surface S2 may be provided on an etched portion of the first semiconductor layer 111 below the upper surface of the first semiconductor layer 111 in a direction parallel to the surface of the substrate 110. The third surface S3 may be provided from the first semiconductor layer 111 to the second semiconductor layer 113 in a direction perpendicular to the surface of the substrate 110. The extension of the first electrode 121 may further include a surface extending in the first direction (X direction) from an end of the third surface S3.

The light source 120 may include a plurality of reflective surfaces (for example, a first reflective surface and a second reflective surface) provided apart from each other on the substrate 110 in the first direction (X direction). The first surface S1 of the first electrode 121 may be a first reflective surface. The first reflective surface, which is the first surface S1 of the first electrode 121, may be provided in the third direction (Z direction) perpendicular to the substrate 110. The light source 120 may include a second reflective surface 123 provided in the third direction (Z direction) perpendicular to the substrate 110. The second reflective surface 123 may be spaced apart in the first direction (X direction) from the first reflective surface, which is the first surface S1 of the first electrode 121. The second reflective surface 123 may be adjacent to, in the first direction (X direction), the waveguide 140 provided between the light source 120 and a ring resonator 130, and the first reflective surface, which is the first surface S1 of the first electrode 121, may be apart from the second reflective surface 123 in the first direction (X direction). For example, the second reflective surface 123 may include SiO₂. The first reflective surface, which is the first surface S1 of the first electrode 121, may include a material (the material included in the first electrode 121) having a higher reflectance than a reflectance of the second reflective surface 123.

According to one or more embodiments, the PIC 100 may more effectively reduce the length of the cavity of the light source 120 because the reflective surfaces of the light source 120 have high reflectance due to the use of an electrode material. Furthermore, in the PIC 100 of the one or more embodiments, the trench T exposes a portion of the first semiconductor layer 111 including a material with high thermal conductivity, and the first electrode 121 of the light source 120, which is an electrode having high reflectance, is provided in the trench T, such that heat generated in the light source 120 or the like may be quickly dissipated through the first electrode 121. For example, the substrate 110 of the PIC 100 may operate as a heat sink. Therefore, the PIC 100 of the one or more embodiments may implement a multi-wavelength light source with a relatively small area.

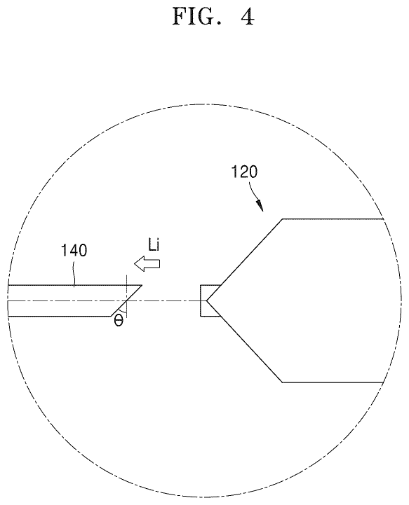

FIG. 4 is a schematic enlarged diagram illustrating a region C of FIG. 2. FIG. 4 is described below with reference to FIGS. 1 and 2.

Referring to FIG. 4, light Li emitted from the light source 120 may be incident on an end of the waveguide 140 that is adjacent to and spaced apart from the light source 120. When viewed in the third direction (Z direction) perpendicular to the surface of the substrate 110, the end of the waveguide 140 adjacent to the light source 120 may have a slanted shape at an angle with respect to the first direction (X direction). When viewed in the third direction (Z direction) perpendicular to the surface of the substrate 110, the end of the waveguide 140 adjacent to the light source 120 may have a shape slanted with respect to a direction (Y direction) perpendicular to a direction (opposite to the first direction (X direction)) in which light Li is incident. For example, when viewed in the third direction (Z direction) perpendicular to the surface of the substrate 110, the end of the waveguide 140 adjacent to the light source 120 may not be perpendicular to the direction (opposite to the first direction (X direction)) in which light Li emitted from the light source 120 is incident.

When viewed in the third direction (Z direction) perpendicular to the surface of the substrate 110, θ refers to an angle between the end of the waveguide 140 adjacent to the light source 120 and the second direction (Y direction) perpendicular to the direction (opposite to the first direction (X direction)) in which light Li is incident, and the angle θ may be greater than 0°. For example, the angle θ between the end of the waveguide 140 adjacent to the light source 120 and the second direction (Y direction) perpendicular to the direction (opposite to the first direction (X direction)) in which light Li is incident may range from about 3° to about 17°.

For example, the end of the waveguide 140 adjacent to the light source 120 may have a slanted shape with respect to a plane (Y-Z plane) perpendicular to the direction in which light Li is incident. The angle θ between the end of the waveguide 140 adjacent to the light source 120 and the plane (Y-Z plane) perpendicular to the direction (opposite to the first direction (X direction)) in which light Li is incident may range from about 3° to about 17°.

Because the surface of the end of the waveguide 140 adjacent to the light source 120 is slanted with respect to the direction perpendicular to the direction in which light Li is incident, a backscattering phenomenon in which light Li emitted from the light source 120 undergoes multiple reflections instead of entering the waveguide 140 may be prevented.

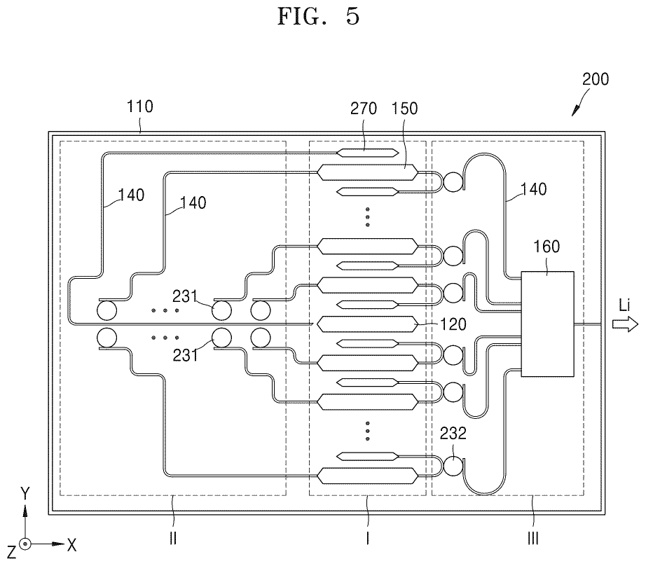

FIG. 5 is a schematic diagram illustrating a PIC 200 according to one or more other embodiments. FIG. 5 is described with reference to FIG. 1, focusing on the difference from FIG. 1. In FIGS. 1 and 5, like reference numerals denote like elements, and repeated descriptions thereof are omitted.

Referring to FIG. 5, the PIC 200 may include a substrate 110, a light source 120, a waveguide 140, and at least one optical element. The light source 120, the waveguide 140, and the at least one optical element may be provided on the substrate 110. The at least one optical element may include, for example, at least one selected from ring filters 231, ring modulators 232, photodetectors 270, optical amplifiers 150, and an optical coupler 160. The photodetectors 270 may include photodiodes. Light split by the ring filters 231 may be individually amplified by the optical amplifiers 150, and the optical power of the light may be controlled for each wavelength according to longitudinal modes by monitoring the light with the photodetector 270.

The photodetectors 270 may include a Group III-V compound semiconductor material. The light source 120, the optical amplifiers 150, and the photodetectors 270 of the PIC 200 may be provided in one region (hereinafter referred to as a first area I) of the substrate 110. The first region I of the substrate 110 may be a center region of a surface (for example, an upper surface of a second semiconductor layer) of the substrate 110. The first region I of the substrate 110 may be, for example, a rectangular region with a width in a first direction (X direction) and a length in a second direction (Y direction). Optical elements other than the light source 120, the optical amplifiers 150, and the photodetectors 270 may be provided in regions other than the first region I of the substrate 110.

In the PIC 200 of the one or more other embodiments, optical elements requiring a Group III-V compound semiconductor material are integrated in the first region I of the substrate 110, and thus, the substrate 110 may include a small amount of the Group III-V compound semiconductor material.

At least one of the ring filters 231, the ring modulators 232, and the optical coupler 160 may be provided in regions other than the first region I of the substrate 110 (for example, in a second region II and a third region III of the substrate 110). For example, the ring filters 231 may be provided in the second region II located beside the first region I of the substrate 110 in the opposite direction of the first direction (X direction), and the ring modulators 232 may be provided in the third region Ill located beside the first region I of the substrate 110 in the first direction (X direction). In addition, the optical coupler 160 may be provided in the third region III located beside the first region I of the substrate 110 in the first direction (X direction).

In the PIC 200 of the one or more other embodiments, ring resonators are divided into the ring filters 231 and the ring modulators 232, and thus, the linewidth of each wavelength may be improved due to characteristics of the ring resonators, thereby improving the quality of the light source 120. In addition, the photodetectors 270 may be reverse bias elements generating a relatively small amount of heat and may thus be provided between the light source 120 and the optical amplifiers 150. Moreover, the ring filters 231 or the ring modulators 232 may each have a diameter of less than or equal to about 10 μm, and an increase in the area of the PIC 200 of the one or more other embodiments may not be significant compared to the PIC 100 shown in FIG. 1.

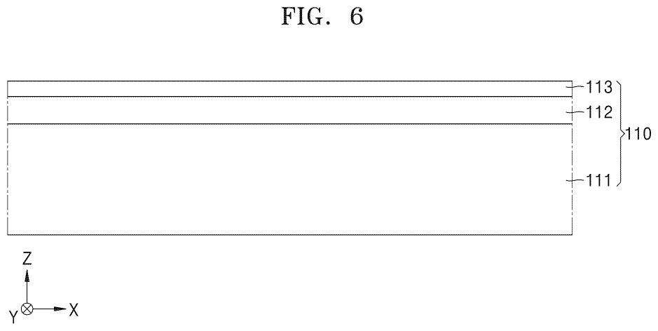

FIGS. 6 to 11 are schematic diagrams illustrating a method of manufacturing a PIC according to one or more embodiments. The same reference numerals as those mentioned in the description of FIG. 1 denote the same elements, and repeated descriptions thereof are omitted.

Referring to FIG. 6, a substrate 110 may be formed by sequentially stacking a first semiconductor layer 111, a dielectric layer 112, and a second semiconductor layer 113. The substrate 110 formed by sequentially stacking the first semiconductor layer 111, the dielectric layer 112, and the second semiconductor layer 113 may be an SOI substrate.

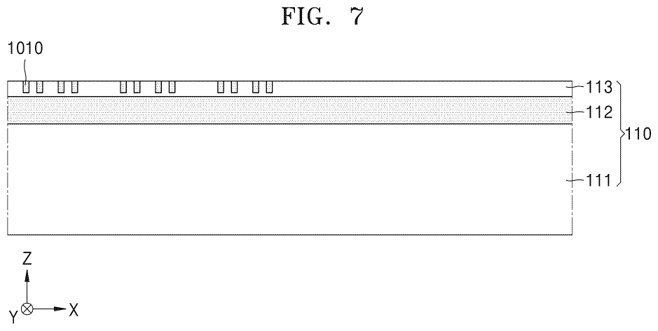

Referring to FIG. 7, a waveguide and ring resonators (ring filters or ring modulators) may be patterned on the substrate 110. The second semiconductor layer 113 may be etched according to the pattern of the ring resonators and the waveguide, and etched portions of the substrate 110 may be refilled with a dielectric material 1010 acting as a cladding of the waveguide. For example, the dielectric material 1010 may include silicon oxide (for example, SiO₂). Thereafter, a planarization process (for example, a chemical mechanical polishing (CMP) process) may be performed on the substrate 110.

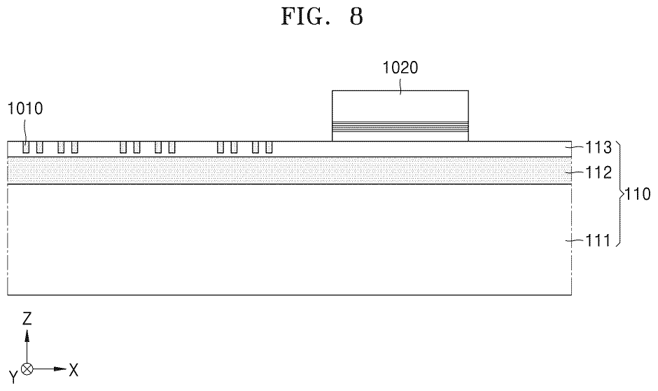

Referring to FIG. 8, a Group III-V compound semiconductor material 1020 may be bonded to an upper surface of the substrate 110 and may be patterned by etching. High-precision alignment between a light source and the waveguide may be possible by hybrid-bonding patterning.

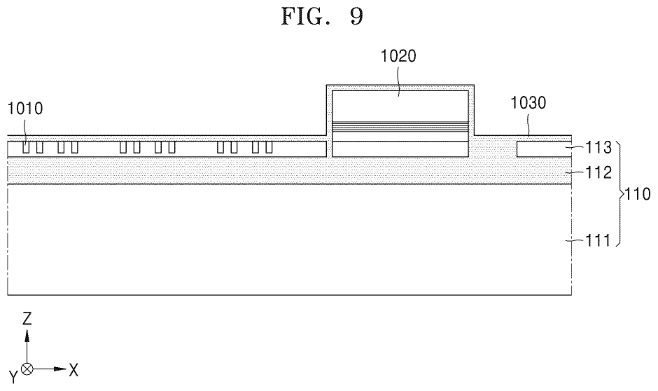

Referring to FIG. 9, the second semiconductor layer 113 of the substrate 110 may be etched and patterned to form reflective surfaces of the light source, and etched portions of the second semiconductor layer 113 may be filled with a dielectric material 1030. In this case, as shown in FIG. 4, an end of the waveguide adjacent to the light source may be slanted with respect to a direction perpendicular to a direction in which light is incident.

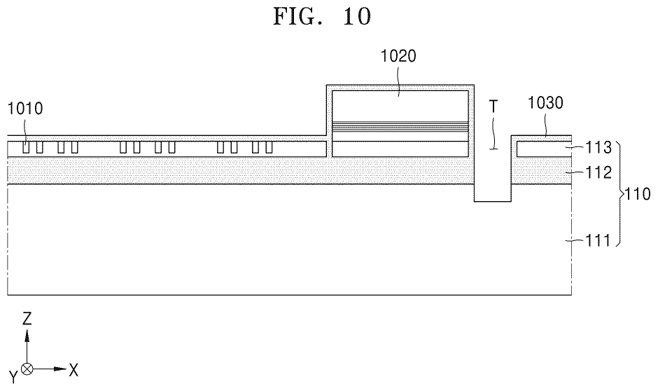

Referring to FIG. 10, a trench T may be patterned by etching portions of the dielectric material 1030, the second semiconductor layer 113, the dielectric layer 112, and the first semiconductor layer 111 in a region adjacent to the Group III-V compound semiconductor material 1020 of the substrate 110. The trench T may be formed by performing etching until a portion of a surface of the first semiconductor layer 111 having high thermal conductivity is exposed.

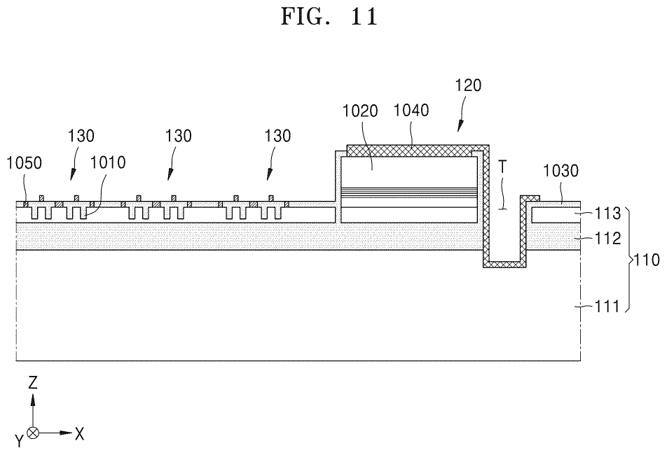

Referring to FIG. 11, the dielectric material 1030 may be patterned by selective etching, and electrodes 1040 and 1050 may be deposited in etched regions. When anode and cathode materials are different, the deposition process of the electrodes 1040 and 1050 may be divided according to the types of the electrodes 1040 and 1050. The electrodes 1040 and 1050 may be deposited by a method such as deposition after patterning, lift-off, or patterning and etching after deposition. The electrode 1040 of a light source 120 may be formed by depositing an ohmic metallic material in an anode contact region, and then depositing a metal having a highly reflective surface through additional patterning. This process may prevent a decrease in reflectivity that may occur when the ohmic metallic material first forms a reflective surface of the light source 120.

The PICs 100 and 200 of the one or more embodiments may provide multi-wavelength light sources for light source-integrated PICs, which are required for conversion to wavelength division multiplexing (WDM) optical interconnection in memory-to-memory communication, XPU-to-memory communication (where XPU may be a central processing unit (CPU), a graphics processing unit (GPU), etc.), or XPU-to-XPU data transmission.

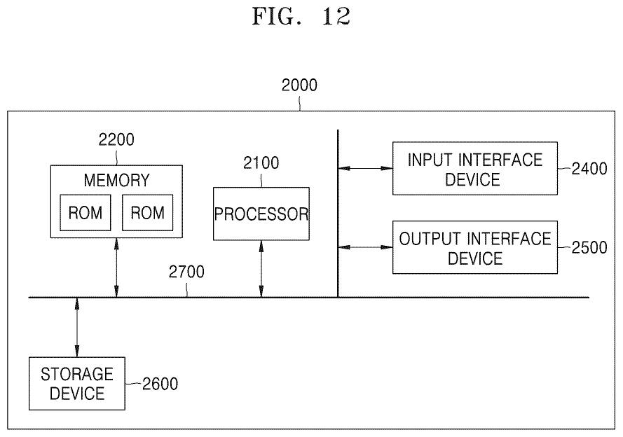

FIG. 12 is a schematic block diagram illustrating an electronic apparatus 2000 including a PIC, according to one or more embodiments.

Referring to FIG. 12, according to the one or more embodiments, the electronic apparatus 2000 including a PIC may include at least one processor 2100 and memory 2200 that stores instructions for directing the at least one processor 2100 to perform at least one operation.

In addition, according to the one or more other embodiments, the electronic apparatus 2000 including a PIC may further include an input interface device 2400, an output interface device 2500, a storage device 2600, and the like. According to the one or more other embodiments, components of the electronic apparatus 2000 including a PIC may be connected to each other through a waveguide 2700 and may communicate with each other.

For example, the at least one processor 2100 may refer to an XPU or a dedicated processor configured to perform various operations for controlling the PIC according to one or more one or more other embodiments. Each of the memory 2200 and the storage device 2600 may include at least one selected from a volatile storage medium and a non-volatile storage medium. For example, the memory 2200 may include at least one selected from read-only memory (ROM) and random access memory (RAM).

As described above, according to one or more of the one or more embodiments described above, the PIC may effectively reduce the length of the cavity of the light source because the reflective surfaces of the light source have high reflectance owing to the use of an electrode material. Furthermore, in the PIC, the trench exposes a portion of a layer including a material with high thermal conductivity, and the extension of a highly reflective electrode of the light source is provided in the trench, such that heat generated in the light source or the like may be quickly dissipated through the extension. Therefore, the PIC may implement a multi-wavelength light source with a relatively small area.

Moreover, in the PIC, optical elements requiring a Group III-V compound semiconductor material are integrated in one region of the substrate, and thus, the substrate may include a small amount of the Group III-V compound semiconductor material.

It should be understood that embodiments described herein should be considered in a descriptive sense only and not for purposes of limitation. Descriptions of features or aspects within each embodiment should typically be considered as available for other similar features or aspects in other embodiments. While embodiments have been described with reference to the figures, it will be understood by those of ordinary skill in the art that various changes in form and details may be made therein without departing from the spirit and scope as defined by the following claims and their equivalents.

What is claimed is:

1. A photonic integrated circuit comprising:
a substrate comprising a trench;
a light source on the substrate and adjacent to the trench, the light source comprising a first electrode and a second electrode that are in an upper portion of the light source;
at least one optical element on the substrate and optically connected to the light source; and
a waveguide between the light source and the at least one optical element,
wherein the substrate comprises a first semiconductor layer, a dielectric layer on the first semiconductor layer, and a second semiconductor layer on the dielectric layer,
wherein the trench penetrates the second semiconductor layer and the dielectric layer to a level of the first semiconductor layer, and
wherein the first electrode comprises an extension on a side wall surface of the light source and in the trench, the light source further comprises a first reflective surface and a second reflective surface that are spaced apart from each other, the first reflective surface being the extension of the first electrode.

2. The photonic integrated circuit of claim 1, wherein the light source comprises a Group III-V compound semiconductor material, and the at least one optical element comprises a plurality of ring resonators and a plurality of optical amplifiers.

3. The photonic integrated circuit of claim 1, wherein the light source is a Fabry-Perot hybrid laser diode, and the at least one optical element comprises a plurality of ring resonators and a plurality of optical amplifiers.

4. The photonic integrated circuit of claim 1, wherein the extension of the first electrode comprises a first surface, a second surface, and a third surface,
wherein the first surface extends from an end of the upper portion of the light source to the first semiconductor layer along the side wall surface of the light source, the second surface extends from an end of the first surface in a direction parallel to the first semiconductor layer, the third surface extends from an end of the second surface to the second semiconductor layer, and
wherein the first reflective surface is the first surface.

5. The photonic integrated circuit of claim 1, wherein an end of the waveguide through which light emitted from the light source enters the waveguide is at an angle with respect to a plane perpendicular to a direction in which the light enters the waveguide.

6. The photonic integrated circuit of claim 1, wherein the angle between an end of the waveguide, through which light emitted from the light source enters the waveguide, and a plane perpendicular to a direction in which the light enters the waveguide is within a range of 3 degrees to 17 degrees.

7. The photonic integrated circuit of claim 1, wherein the at least one optical element comprises at least one optical amplifier and at least one photodetector, and
wherein the light source, the at least one optical amplifier, and the at least one photodetector each comprise a Group III-V compound semiconductor material and are in a region of the substrate.

8. The photonic integrated circuit of claim 1, wherein the at least one optical element comprises at least one optical amplifier and at least one photodetector, and
wherein the light source, the at least one optical amplifier, and the at least one photodetector each comprise a Group III-V compound semiconductor material and are in a region of the substrate that is a rectangular region at a center of a surface of the substrate.

9. The photonic integrated circuit of claim 1, wherein the at least one optical element comprises an optical coupler, at least one ring resonator, at least one optical amplifier, and at least one photodetector, and
wherein the light source, the at least one optical amplifier, and the at least one photodetector each comprise a Group III-V compound semiconductor material and are in a first region of the substrate, and the optical coupler and the at least one ring resonator are in a second region of the substrate different from the first region of the substrate.

10. The photonic integrated circuit of claim 1, wherein the at least one optical element comprises an optical coupler, at least one ring filter, at least one ring modulator, at least one optical amplifier, and at least one photodetector, and
wherein the light source, the at least one optical amplifier, and the at least one photodetector each comprise a Group III-V compound semiconductor material and are in a first region of the substrate, the at least one ring filter is in a second region of the substrate different from the first region, and the optical coupler and the at least one ring modulator are in a third region of the substrate different from the first region and the second region.

11. A method of manufacturing a photonic integrated circuit, the method comprising:
providing a substrate by providing a first semiconductor layer, a dielectric layer, and a second semiconductor layer;
providing a light source, a waveguide, and at least one optical element on the substrate;
forming a trench by etching a portion of the substrate, the portion being adjacent to the light source; and
providing a first electrode and a second electrode on the light source,
wherein the trench is formed to penetrate the second semiconductor layer and the dielectric layer to a level of the first semiconductor layer,
wherein the first electrode comprises an extension on a side wall surface of the light source and in the trench, the light source comprises a first reflective surface and a second reflective surface, the first reflective surface being the extension of the first electrode.

12. The method of claim 11, wherein the light source comprises a Group III-V compound semiconductor material, and the at least one optical element comprises a plurality of ring resonators and a plurality of optical amplifiers.

13. The method of claim 11, wherein the light source is a Fabry-Perot hybrid laser diode, and the at least one optical element comprises a plurality of ring resonators and a plurality of optical amplifiers.

14. The method of claim 11, wherein the extension of the first electrode comprises a first surface, a second surface, and a third surface,
wherein the first surface extends from an end of the upper portion of the light source to the first semiconductor layer along the side wall surface of the light source, the second surface extends from an end of the first surface in a direction parallel to the first semiconductor layer, the third surface extends from an end of the second surface to the second semiconductor layer, and
wherein the first reflective surface is the first surface.

15. The method of claim 11, wherein an end of the waveguide through which light emitted from the light source enters the waveguide is at an angle with respect to a plane perpendicular to a direction in which the light enters the waveguide.

16. The method of claim 11, wherein the angle between an end of the waveguide, through which light emitted from the light source enters the waveguide, and a plane perpendicular to a direction in which the light enters the waveguide is within a range of 3 degrees to 17 degrees.

17. The method of claim 11, wherein the at least one optical element comprises at least one optical amplifier and at least one photodetector, and
wherein the light source, the at least one optical amplifier, and the at least one photodetector each comprise a Group III-V compound semiconductor material and are in a region of the substrate.

18. The method of claim 11, wherein the at least one optical element comprises at least one optical amplifier and at least one photodetector, and
wherein the light source, the at least one optical amplifier, and the at least one photodetector each comprise a Group III-V compound semiconductor material and are in a region of the substrate that is a rectangular region at a center of a surface of the substrate.

19. The method of claim 11, wherein the at least one optical element comprises an optical coupler, at least one ring resonator, at least one optical amplifier, and at least one photodetector, and
wherein the light source, the at least one optical amplifier, and the at least one photodetector each comprise a Group III-V compound semiconductor material and are in a first region of the substrate, and the optical coupler and the at least one ring resonator are in a second region of the substrate different from the first region of the substrate.

20. The method of claim 11, wherein the at least one optical element comprises an optical coupler, at least one ring filter, at least one ring modulator, at least one optical amplifier, and at least one photodetector, and
wherein the light source, the at least one optical amplifier, and the at least one photodetector each comprise a Group III-V compound semiconductor material and are in a first region of the substrate, the at least one ring filter is in a second region of the substrate different from the first region, and the optical coupler and the at least one ring modulator are in a third region of the substrate different from the first region and the second region.
